(19) United States
(12) Patent Application Publication
(10) Pub. No.: US 2004/0054727 A1
(43) Pub. Date: Mar. 18, 2004

(54) Access system to at least a co-operative work environment

(76) Inventors: Pascal Reiter, Villers Les Nancy (FR); Chantal Thiel, Heillecourt (FR); Gilles Didelot, Laxou (FR)

Correspondence Address: YOUNG & THOMPSON, 745 SOUTH 23RD STREET 2ND FLOOR, ARLINGTON, VA, 22202

(21) Appl. No.: 10/362,230

(22) PCT Filed: Aug. 17, 2001
(86) PCT No.: PCT/FR01/02627

(30) Foreign Application Priority Data
Aug. 22, 2000 (FR) 00 10810

(51) Int. Cl. G06F 15/16

(52) U.S. Cl. 709/205

(57) ABSTRACT

The invention concerns a system for access to at least a co-operative work environment (14) accessible by at least a terminal (38, 42, 44) provided with a co-operative work software, through a data transmission network (34), and comprising at least a conference server (10, 12) adapted to host the co-operative work environment (14). It comprises means (18, 20) managing access to the co-operative work environment (14) including a first part (18) forming a data exchange interface with a user of the terminal (38, 42, 44) for access to the co-operative work environment (14) and a second part (20) adapted to ensure automatically both the launching of the co-operative work software (14) and the management of the connection to the conference server on the basis of data derived from the first part (18), and means (24, 26) for managing the monitoring of access to the co-operative work environment.

The present invention relates to an access system to at least one co-operative work environment accessible by at least one terminal provided with co-operative work software, access being via an information transmission network, and the system including at least one conference server adapted to host the co-operative work environment.

A co-operative work environment is a memory zone reserved on one of the conference servers 10, 12 and accessible for reading and writing by a limited number of users.

Such access systems are known. At present, an access system to at least one co-operative work environment comprises a conference server compatible with international standard T120 and accessible via an information transmission network that supports the Internet communications protocol, and referred to below as an IP network.

A user seeking to access a co-operative work environment from a terminal provided with co-operative work software implementing the T120 standard activates said software and must also connect to the conference server hosting the co-operative work environment in question.

Such a system requires the user to know the universal address of the conference server, and possibly also of the co-operative work environment on the IP network. In addition, the complexity of such an access system constitutes a brake to its use by users who are unfamiliar with information technology.

The invention seeks to remedy the drawback of conventional access systems by creating an access system that is simple to use.

The invention thus provides an access system to at least one co-operative work environment accessible by at least one terminal provided with co-operative work software, access being via an information transmission network, and the system including at least one conference server adapted to host the co-operative work environment, the system being characterized in that it comprises firstly means for managing access to the co-operative work environment, said means comprising a first portion forming an information exchange interface with a user of the terminal for accessing the co-operative work environment, and a second portion adapted to operate automatically both to launch the co-operative work software and to manage making the connection to the conference server as a function of information issued by the first portion, and in that it comprises secondly means for following up access to the co-operative work environment.

An access system of the invention thus enables a user to access a co-operative work environment via an interface that is simple, the system acting automatically and without requiring intervention from the user to take charge of launching the co-operative work software, to connect to the conference server, and to follow up access to the co-operative work environment.

An access system of the invention to at least one co-operative work environment may further comprise one or more of the following characteristics:

it comprises an access server connected to the information transmission network including the means for managing access and means for making the second portion of the means for managing access available by downloading to said terminal;

the co-operative work software and the conference server comply with international standard T120;

the information from the first portion includes data identifying the co-operative work environment associated with a password;

the means for managing access to the co-operative work environment include control means for creating the co-operative work environment in the conference server as a function of information coming from the first portion;

the means for following up access comprise means for dynamically dimensioning the co-operative work environment in the conference server as a function of the number of users of said co-operative work environment;

the means for following up access comprise means for automatically deleting the co-operative work environment from the conference server in the event of said environment remaining inactive for longer than a predetermined length of time;

the means for following up access comprise billing means for billing the connections set up between the terminal and the conference server; and

it comprises a plurality of conference servers and the means for following up access comprise means for allocating the co-operative work environment to any one of the conference servers as a function of server availability.

The invention will be better understood from the following description given purely by way of example and made with reference to the accompanying drawings, in which:

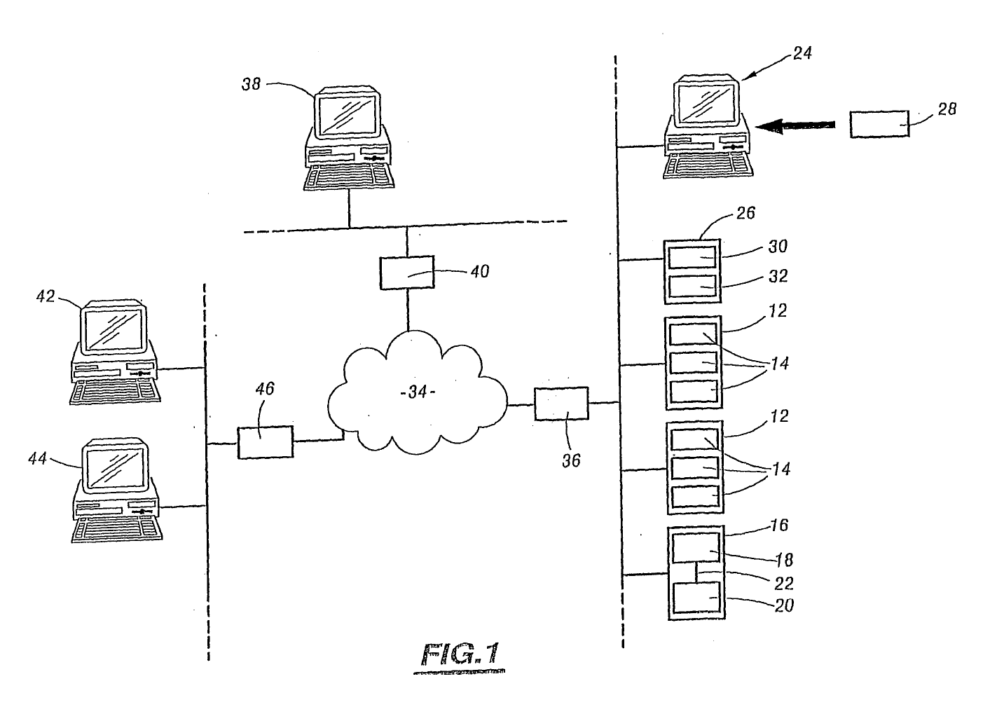

FIG. 1 is a diagram showing the structure of an access system of the invention; and

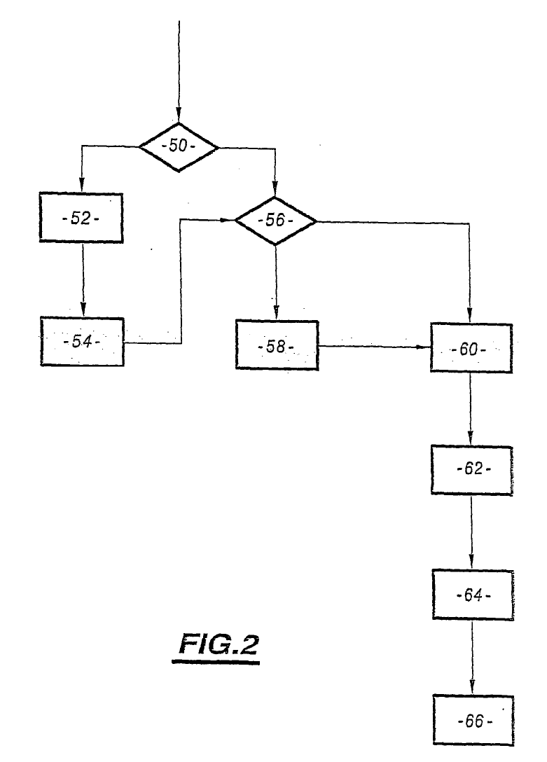

FIG. 2 is a flow chart giving details of the operation of the access system shown in FIG. 1.

An access system as shown in FIG. 1 comprises a plurality of conference servers 10, 12 each hosting a plurality of co-operative work environments 14.

The system also comprises an access server 16 conventionally in the form of a Web server, comprising an information exchange interface 18 conventionally in the form of a set of presentation pages in hypertext mark-up language (HTML) format. The access server 16 also has access software 20 adapted automatically to launch co-operative work software and to manage connecting a terminal to one of the conference servers 10, 12 hosting a required co-operative work environment 14. A hypertext link 22 is established on the access server 16 via the interface 18 to the access software 20 to enable the access software 20 to be downloaded.

A server 26 for following up access to the co-operative work environments 14 is connected in a local network with the conference servers 10 and 12 and the access server 16, and comprises both means 30 for allocating co-operative work environments 14 in the various conference servers 10, 12 as a function of their availability and means 32 for dynamically allocating memory for a co-operative work environment 14 as a function of the way it varies over time.

Similarly, an operator terminal 24 is connected in the same local network as the conference servers 10 and 12, the access server 16 and the server 26 for following up access, to enable the servers to be consulted. The terminal also includes billing software 28 of conventional type.

The conference servers 10, 12 and the access server 16 are connected to an information transmission network 34 of the IP network type, by means of a conventional router 36.

Remote client terminals are also connected to the information transmission network 34. These terminals include a first client terminal 38 situated, for example, at a first remote site and connected to the network 34 by means of a router 40. Two other client terminals 42 and 44 are situated, for example, at a second remote site and are both connected to the network 34 by means of a router 46. Each of the terminals 38, 42, and 44 is provided with co-operative work software complying with the international T120 standard (not shown), and also software (not shown) for navigating on the network 34, enabling the terminal to access the information exchange interface 18 of the access server 16.

For a user of one of the client terminals 38, 42, or 44, the above-described system operates in the manner shown diagrammatically in FIG. 2.

A first user of the system accessing the network 34 from the terminal 38 might desire, for example, to work together with two other users who access the network 34 from terminals 42 and 44 respectively.

To do this, the user makes a connection to the information exchange interface 18 of the access server 16 by entering the corresponding universal address in the navigation software.

During an initial welcoming step 50, the information exchange interface 18 gives the user the option to choose between creating a new co-operative work environment 14 and participating in an already-created co-operative work environment.

As organizer of the common work session, the first user opts for creating a new co-operative work environment 14 and moves onto registration step 52.

During this step 52, the information exchange interface 18 seeks to register data identifying the new co-operative work environment 14. The first user selects this identity data so as to identify the co-operative work environment 14 and associate said data with a password. Once the data has been confirmed, the system moves onto a creation step 54.

During this step 54, the access server 16 transmits the information previously obtained during step 52 to the means 30 for allocating co-operative work environments 14. As a function of the availability of the various conference servers 10, 12 in the system, the allocation means 30 select the conference server which is to host the new co-operative work environment 14.

Following this step, the first user can choose to participate in a co-operative work environment 14, and in particular in the environment which has just been created, during a log-on step 56.

Similarly, the users of terminals 42 and 44, seeking merely to participate in the co-operative work environment 14 created by the organizer, pass directly to log-on step 56 after selecting the option to participate in a co-operative work environment 14 during step 50.

In the description below concerning operation, the term “user” is used to cover any of the users of the terminals 38, 42, and 44.

During log-on step 56, the information exchange information 18 informs the user that if this is the first occasion on which that user is going to participate in a co-operative work environment 14 of the system, then it is necessary to install the access software 20 on the client terminal. Thereafter, the system moves onto a downloading step 58 should that be necessary, otherwise it moves onto a selection step 60.

During the downloading step 58, the user accesses the access software 20 via the hypertext link 22 and downloads it in conventional manner into the user's terminal. The system then moves onto selection step 60.

During step 60, the information exchange interface 18 gives the user a list of already-created co-operative work environments, including the co-operative work environment 14 previously created by the first user during step 54.

After selecting the previously created co-operative work environment 14, the user moves onto a registration step 62 during which the user's selection is confirmed by inputting a password associated with the name of the co-operative work environment 14. The organizer of this co-operative work session will naturally already have given the password to the other two users who are authorized to participate in this session.

After the data input by the user has been confirmed, the system moves onto a step 64 of accessing the co-operative work environment 14. During this step, and without intervention from the user, the access software 20 causes the co-operative work software installed on the terminals 38, 42, or 44 to be launched and also causes a connection to be made to the conference server 10 or 12 hosting the selected co-operative work environment 14. Simultaneously, the billing software 28 is informed so that the participation time of the user in the co-operative work environment 14 is billed in conventional manner. The memory allocation means 32 are also informed so as to reserve a zone of sufficient memory on the conference server hosting the selected co-operative work environment 14, as a function of the number of users participating in this co-operative work environment at any instant.

During a final step 66 for ending participation, the server 26 for following up access receives a user end-of-participation signal from the co-operative work environment 14. This signal is transmitted to the other participants via the co-operative work environment 14 in the form of an end-of-participation sound signal.

When all of the participants have left the co-operative work environment 14, it becomes inactive after a predetermined time lapse, for example 15 minutes. The allocation means 30 then release the memory zone allocated to said co-operative work environment 14 on the conference server 10 or 12 corresponding thereto and delete the name of the co-operative work environment 14 from the list displayed in step 60 via the information exchange interface 18.

It can clearly be seen that a system of the invention serves to facilitate access to a co-operative work environment for a user whether organizing or participating in a co-operative work environment 14, by making an information exchange interface 18 available to the user that is simple and that is associated with access software 20 that can be downloaded on the user's terminal, said access software 20 operating automatically without intervention by the user to launch the co-operative operative work software installed on the user's terminal and to make a connection to the conference server 10, 12 hosting the co-operative work environment 14 selected by the user.

1/ An access system to at least one co-operative work environment (14) accessible by at least one terminal (38, 42, 44) provided with co-operative work software, access being via an information transmission network (34), and the system including at least one conference server (10, 12) adapted to host the co-operative work environment (14), the system being characterized in that it comprises firstly means (18, 20) for managing access to the co-operative work environment (14), said means comprising a first portion (18) forming an information exchange interface with a user of the terminal (38, 42, 44) for accessing the co-operative work environment (14), and a second portion (20) adapted to operate automatically both to launch the co-operative work software and to manage making the connection to the conference server as a function of information issued by the first portion (18), and in that it comprises secondly means (24, 26) for following up access to the co-operative work environment.

2/ An access system to at least one co-operative work environment (14) according to claim 1, characterized in that it comprises an access server (16) connected to the information transmission network (34) including the means (18, 20) for managing access and means (22) for making the second portion (20) of the means for managing access available by downloading to said terminal (38, 42, 44).

3/ An access system to at least one co-operative work environment (14) according to claim 1 or claim 2, characterized in that the co-operative work software and the conference server comply with international standard T120.

4/ An access system to at least one co-operative work environment (14) according to any one of claims 1 to 3, characterized in that the information from the first portion (18) includes data identifying the co-operative work environment (14) associated with a password.

5/ An access system to at least one co-operative work environment (14) according to any one of claims 1 to 4, characterized in that the means (18, 20) for managing access to the co-operative work environment (14) include control means for creating the co-operative work environment in the conference server (10, 12) as a function of information coming from the first portion.

6/ An access system to at least one co-operative work environment (14) according to any one of claims 1 to 5, characterized in that the means (24, 26) for following up access comprise means (32) for dynamically dimensioning the co-operative work environment (14) in the conference server (10, 12) as a function of the number of users of said co-operative work environment.

7/ An access system to at least one co-operative work environment (14) according to any one of claims 1 to 6, characterized in that the means (24, 26) for following up access comprise means for automatically deleting the co-operative work environment (14) from the conference server (10, 12) in the event of said environment remaining inactive for longer than a predetermined length of time.

8/ An access system to at least one co-operative work environment (14) according to any one of claims 1 to 7, characterized in that the means (24, 26) for following up access comprise billing means (28) for billing the connections set up between the terminal (38, 42, 44) and the conference server (10, 12).

9/ An access system to at least one co-operative work environment (14) according to any one of claims 1 to 8, characterized in that it comprises a plurality of conference servers (10, 12) and in that the means (24, 26) for following up access comprise means (30) for allocating the co-operative work environment (14) to any one of the conference servers as a function of server availability.
